(19) United States
(12) Patent Application Publication
(10) Pub. No.: US 2010/0182213 A1
(43) Pub. Date: Jul. 22, 2010

(54) ANTENNA ARRANGEMENT FOR A MOBILE RADIO BASE STATION (As amended)

(75) Inventors: Johann Obermaier, Weiching (DE); Matthias Riedel, Stephanskirchen (DE); Stephen John Saddington, Vogtareuth (DE)

Correspondence Address: NIXON & VANDERHYE, PC, 901 NORTH GLEBE ROAD, 11TH FLOOR, ARLINGTON, VA, 22203, US

(73) Assignee: Kathrein-Werke AG, Rosenheim (DE)

(21) Appl. No.: 12/376,615

(22) PCT Filed: Jul. 26, 2007
(86) PCT No.: PCT/EP07/06638

§ 371 Date: Feb. 6, 2009

(30) Foreign Application Priority Data
Aug. 10, 2006 (DE) 102006037518.1

(51) Int. Cl. H01Q 9/16; H01Q 21/00; H01Q 19/10

(52) U.S. Cl. 343/817

(57) ABSTRACT

An improved antenna arrangement includes a reflector arrangement comprising a printed circuit board with an electrically conductive ground plane. The reflector arrangement also has a reflector frame with a coupling surface. The coupling surface is capacitively coupled to the ground plane. The coupling surface has a recess via which the ground plane, which is located underneath it, and/or the printed circuit board or an isolating intermediate layer which is provided above the ground plane or an isolating intermediate layer which is provided above the printed circuit board is exposed. The at least one antenna element arrangement is positioned and/or held on the printed circuit board in the area of the recess.

The invention relates to an antenna arrangement, in particular for a mobile radio base station, as claimed in the preamble of claim 1.

An antenna arrangement of this kind is known from EP 1 588 454 B1. According to this anticipatory document the use of, for example, an antenna arrangement, which can be vertically oriented, having a reflector is described, on the vertical lateral limiting lines of which two lateral webs are formed transversely, and in particular perpendicularly, to the reflector plane so as to protrude in the direction of radiation. The dual-polarized radiators arranged one above the other in the vertical direction sit between these lateral webs. According to this anticipatory document also, the base of the supporting mechanism and/or balancing means of the associated radiator assembly is capacitively connected (i.e. without electrical-galvanic contact) to the reflector or coupled thereto by connecting a cap in series, for which purpose the reflector has a recess in which the non-conductive cap engages and is secured and in turn holds the supporting mechanism and/or balancing means or the base of the supporting mechanism and/or balancing means of the dual-polarized radiator. The internal conductor can be installed as is described in the above-mentioned prior art in this case.

A flat antenna can also be gathered as known from DE 697 25 874 T2 and comprises a ground plane layer that is capacitively coupled to a base unit. A dielectric layer is provided between these two layers.

Antenna arrangements, in particular for a mobile radio base station, are also known for example from WO 00/039894 A1. This anticipatory document describes a reflector that can be vertical oriented and on the two vertical and mutually parallel outer, laterally located limits of which a lateral web is formed that protrudes in the direction of radiation and therefore transversely to the reflector plane. A plurality of dipolar arrangements consisting of what are known as vector dipoles and radiating in two mutually perpendicularly oriented polarization planes is provided one above the other in the vertical direction. In terms of construction these vector dipoles are similar to dipole squares. Nevertheless feeding takes place in such a way that despite the horizontally or vertically oriented dipoles, overall the dipole arrangement acts as an X-polarized antenna in which the two polarization planes that are perpendicular to each other are oriented at an angle of +45° or −45° with respect to the vertical or horizontal.

It can be gathered from WO 2005/060049 A1 that the dual-polarized radiators, which sit upstream of a reflector, may be provided with a capacitive outer conductor coupling. Axial holes that run perpendicular to the reflector plane are therefore introduced in each half of the two supporting mechanisms and/or balancing means that are rotated by 90° with respect to each other. Rod-shaped coupling elements 21 that are galvanically connected to the reflector project into these holes and are surrounded by cylindrical insulators onto which the pairs of supporting halves of the dual-polarized radiator assembly that are arranged rotated by 90° with respect to each other can be placed with the total of four axial holes. An internal conductor for feeding the two mutually perpendicular polarizations of the radiator assembly can be laid inside two rod-shaped coupling elements from the back of the reflector in each case.

Finally, antenna arrangements with reflectors are known on the longitudinal lateral regions of which, i.e. on the longitudinal or vertical lateral surfaces of which, longitudinal webs that protrude forwards from the reflector plane are provided, as may be gathered for example from the anticipatory documents WO 99/62138 A1, U.S. Pat. No. 5,710,569 A or EP 0 916 169 B1.

An alternative embodiment according to this anticipatory document discloses that instead of an electrically conductive reflector, conventionally in the form of a metal sheet, a printed circuit board may also be used on which the reflector is constructed. In this case the electrically conductive ground plane is preferably omitted on one side of the printed circuit board or the cap is also provided with insulation in this region.

By contrast, the object of the present invention is to create an improved antenna arrangement which includes beam shaping possibilities and still has a simple construction.

According to the invention the object is achieved in accordance with the features disclosed in claim 1. Advantageous developments of the invention are disclosed in the subclaims.

The invention creates an improved antenna arrangement that can be easily and highly accurately produced with exactly predetermined radiation properties while avoiding potential sources of disruption such as undesirable intermodulations.

It has previously been conventional in the prior art to usually use reflectors made from a metal sheet, the radiator modules being constructed on the reflectors. The longitudinal lateral limits in the form of longitudinal webs and which protrude transversely to the reflector plane can be constructed at a suitable location as a result of the radiators arranged between the lateral external limit of the reflector plane and the, as a rule, centrally arranged radiators. These longitudinal webs could be adjusted for example between a perpendicular orientation with respect to the reflector plane through to an angular orientation in such a way that desired beam shaping was possible.

If, by contrast, one wanted to use reflectors in the form of printed circuit boards (what are referred to as PCBs) which were provided on one side with an electrically conductive ground plane, then this required the webs needed for beam shaping to be connected to the ground plane of the printed circuit board by means of screw connections or soldered joints in order to achieve a definite galvanic connection here. In addition to being laborious this assembly work caused ever potential intermodulation sources or disruption.

By contrast it is now proposed, starting from a printed circuit board which is preferably provided on its radiator side with an electrically conductive ground plane and a insulating layer located above it, to place a reflector frame thereon which is provided with a coupling surface parallel to the ground plane of the printed circuit board, the desired longitudinal and/or transverse webs that are required for diagram shaping in turn being constructed on this coupling surface. In other words, according to the invention a capacitive reflector frame coupling is proposed that allows the longitudinal and/or transverse webs required for diagram shaping to be capacitively coupled to a ground plane sitting on a printed circuit board.

In a preferred embodiment the reflector frame provided according to the invention can be made from an electrically conductive metal, for example aluminum. In particular a reflector frame of this kind can be produced by way of all suitable production processes, for example by a casting process, by shaping, milling, etc. It is also possible to produce a reflector frame of this kind from an electrically non-conductive material, for example plastics material, which is coated with an electrically conductive layer.

In a particularly preferred embodiment the reflector frame is produced from a punching, in particular from a metal sheet, by means of a punching/bending process. In the process it is possible by way of suitable punching and subsequent canting to produce an appropriate three-dimensionally shaped reflector frame from a metal sheet in which the lateral limits or webs are assembled from the metal sheet plane by canting and orientation transverse to the reflector plane. At the same time mutually offset transverse webs can be provided in the add-on direction, whereby the individual radiators or radiator groups are delimited from each other. These transverse webs can also be assembled transversely, and in particular perpendicularly, to the reflector plane by punching and canting or bending.

In a particularly preferred embodiment tongues are formed on the outside of the thus formed transverse webs so as to project away from each other in the axial extension. The tongues can engage in corresponding slotted recesses in the longitudinal lateral limitations if the longitudinal lateral limit has also been assembled in corresponding transverse orientation to the reflector plane following the punching and canting process.

Capacitive coupling of the reflector frame on a printed circuit board without galvanic connection between reflector and printed circuit board ground plane is therefore provided within the scope of the invention. The invention is characterized by a stable intermodulation-free connection. A clearly defined spacing and/or a clearly definable size of the coupling surfaces means that an exactly defined coupling between ground plane of the printed circuit board and the reflector frame may also primarily be ensured within the scope of the invention.

Finally quick and uncomplicated assembly is also possible within the scope of the invention, whereby sources of error are reduced and above all soldered joints are omitted on the reflector.

The completely assembled unit, comprising reflector frame and printed circuit board, forms a self-supporting unit. The reflector frame can be connected to the printed circuit board using any suitable means, for example by means of clips, a double-sided adhesive tape, separate adhesives, etc.

The ground plane on the printed circuit board is preferably originally provided with an insulating layer, for example in the form of paint, in particular a solder resist, a film or some other plastics material layer, which allows metallic isolation from the reflector frame. If the reflector frame is glued by means of a double-sided adhesive tape then this already provides an insulation and therewith metallic isolation between the electrically conductive reflector frame on the one hand and the ground frame on the printed circuit board on the other, so a separate insulating layer can even be omitted on the ground plane.

Further advantages, details and features of the invention emerge from the following embodiments described with reference to figures, in which, in detail:

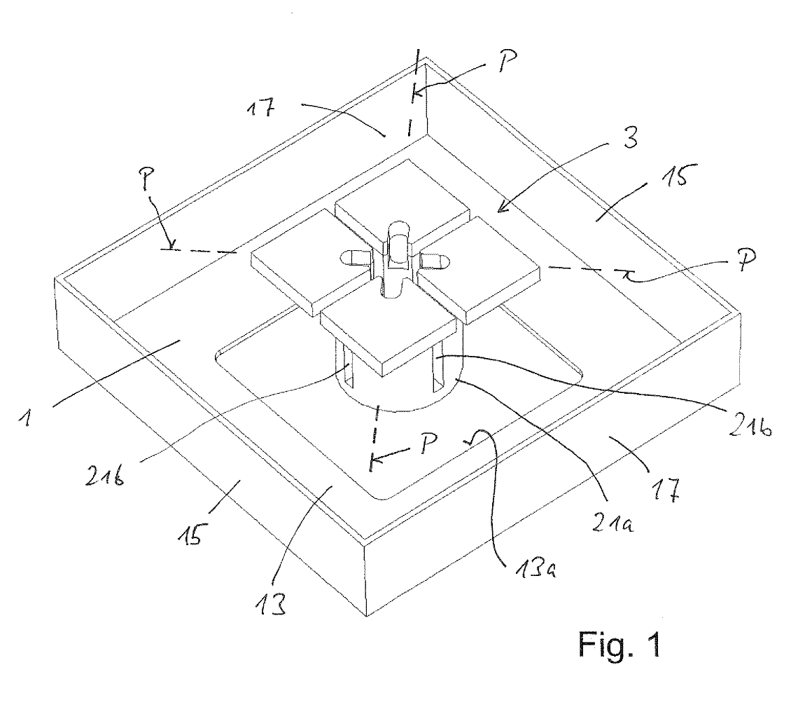

FIG. 1 shows a schematic three-dimensional illustration of a basic type of inventive antenna with a dual-polarized radiator assembly;

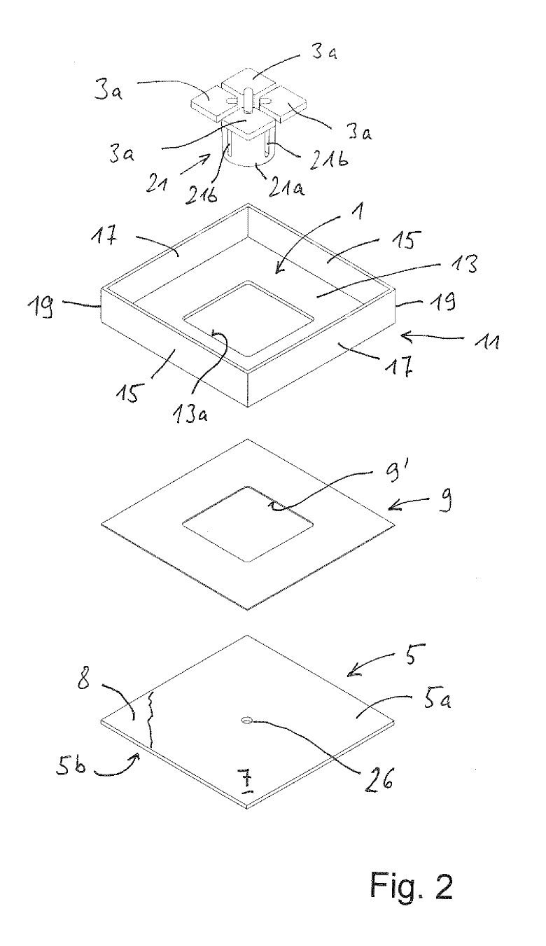

FIG. 2 shows an exploded view of the embodiment of FIG. 1;

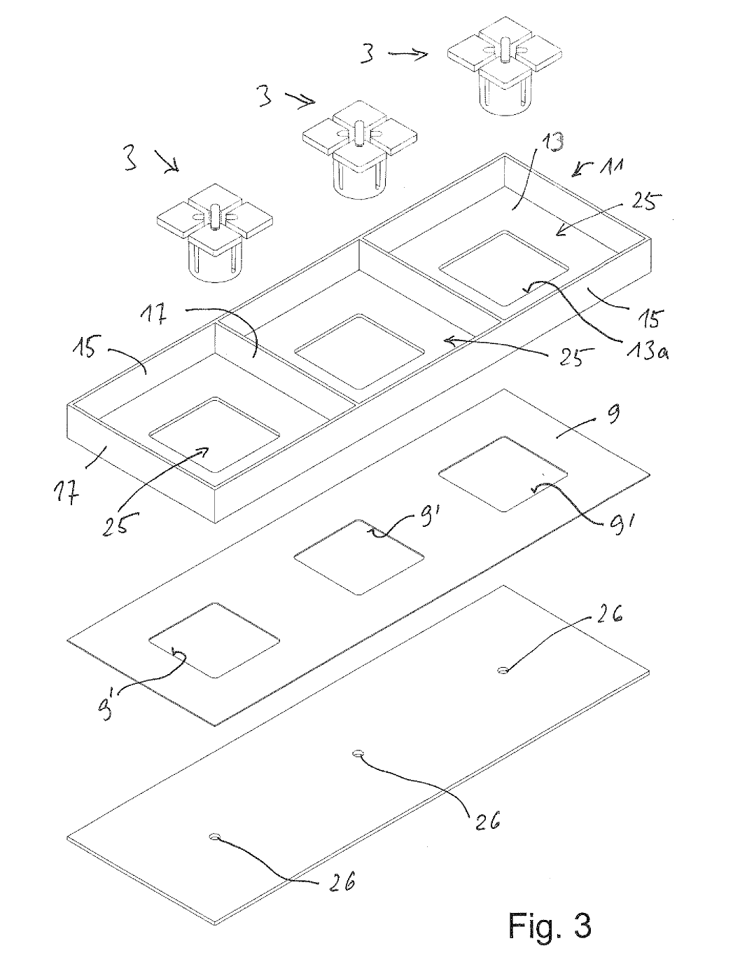

FIG. 3 shows a corresponding exploded view for an inventive antenna arrangement with three mutually offset and dual-polarized radiators;

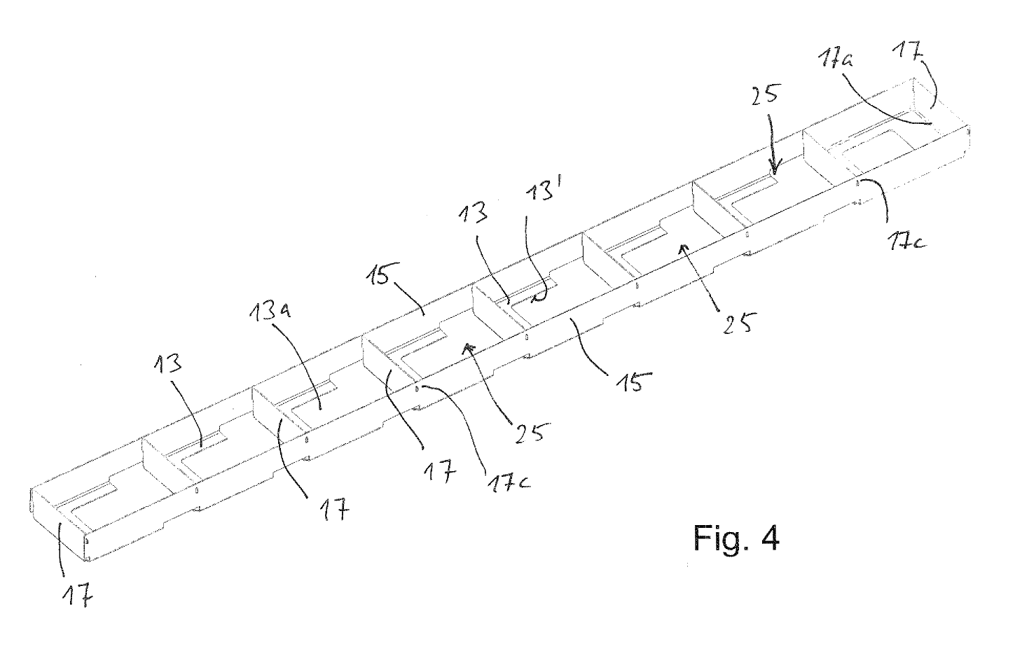

FIG. 4 shows a further embodiment of an inventive reflector frame for, by way of example, eight radiator devices arranged mutually offset in the add-on direction;

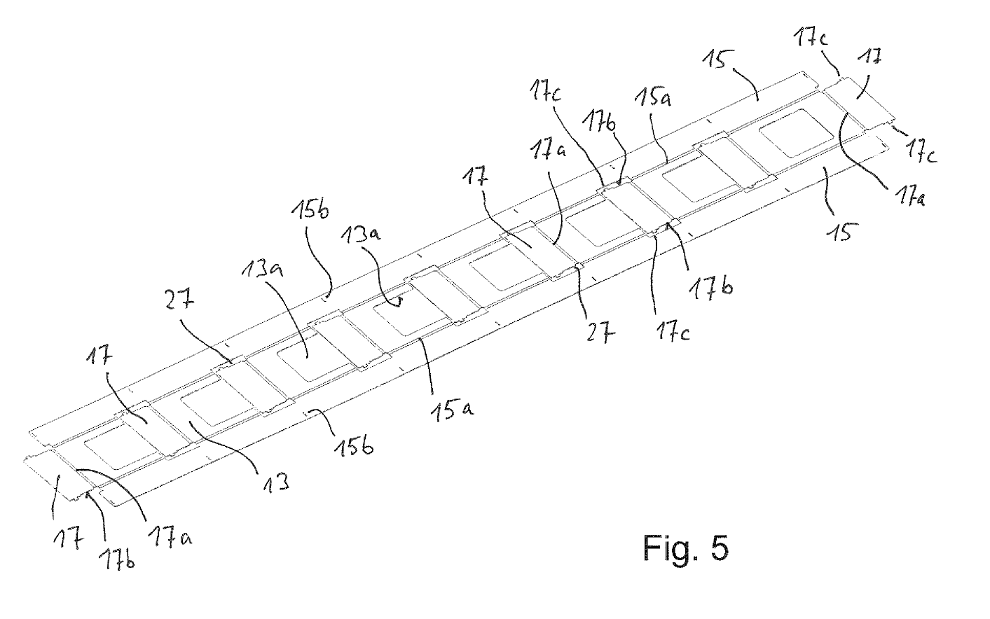

FIG. 5 shows a metal sheet as the starting point for forming a reflector frame, disclosed with reference to FIG. 4, by illustrating the punching lines;

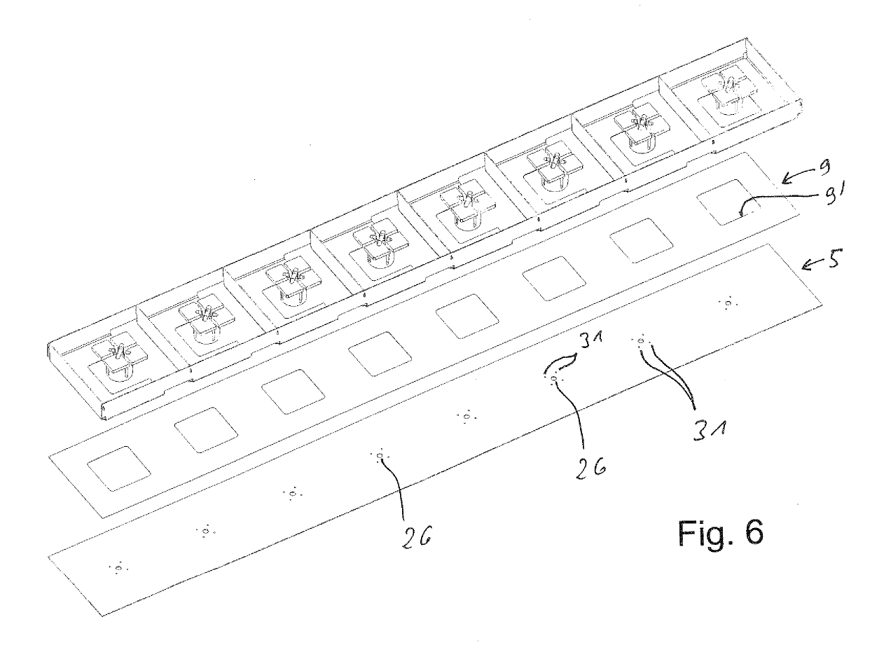

FIG. 6 shows an exploded view of the antenna arrangement for using the reflector frame described with reference to FIGS. 4 and 5;

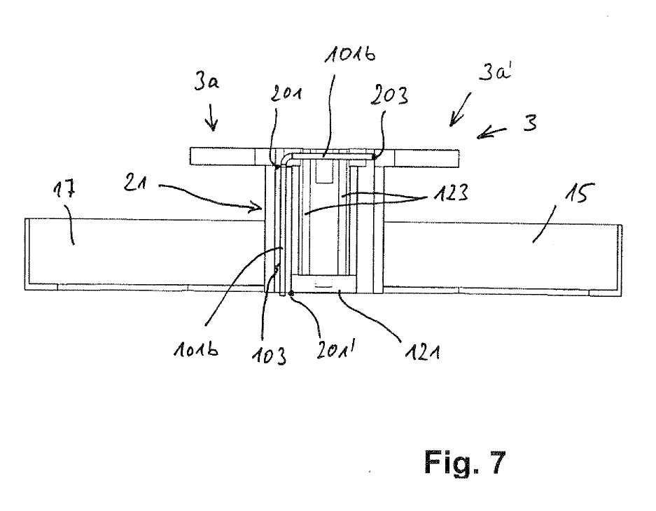

FIG. 7 shows a schematic cross-sectional view through a dual-polarized radiator with a portion of the reflector arrangement to illustrate feeding of the radiator; and

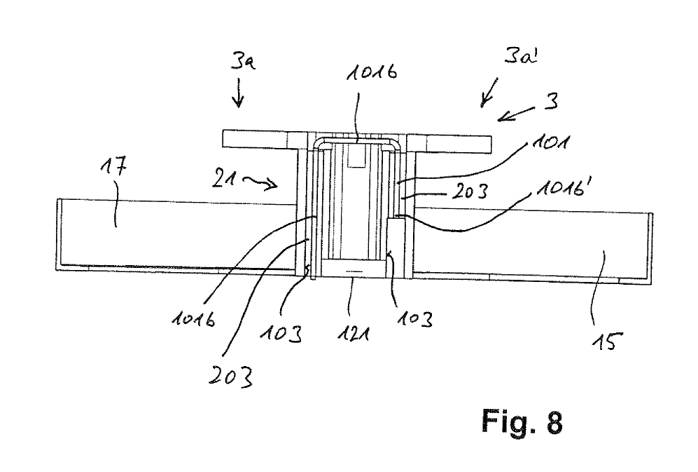

FIG. 8 shows an embodiment that has been modified with respect to FIG. 7.

FIG. 1 shows the basic type of inventive antenna arrangement as can be used for example for a mobile radio base station. The antenna arrangement comprises a reflector arrangement 1, upstream of which a dual-polarized radiator or a dual-polarized radiator assembly 3 is provided. The illustrated embodiment involves a vector dipole which radiates in two mutually perpendicular polarization planes P that are perpendicular to the reflector plane and run more or less diagonally through the corners of the, in plan view, quadratically shaped radiator assembly. Reference is made by way of example to WO 00/039894 A1 with respect to the construction and mode of operation of a radiator of this type.

Basically however any radiator or radiator type can be used within the scope of the invention, in particular dipole radiators and/or patch radiators, as are known for example from anticipatory documents DE 197 22 742 A1, DE 196 27 015 A1, U.S. Pat. No. 5,710,569 A, WO 00/039894 A1 or DE 101 50 150 A1.

The dual-polarized radiator shown in FIGS. 1 and 2 each comprise two pairs of radiator halves 3a that are mutually offset by 90° and are each held by a supporting mechanism and/or balancing means 21 located underneath. In terms of principle the supporting mechanism and/or balancing means 21 is two supporting mechanisms and/or balancing means that are mutually offset by 90° (namely for each polarization), for which purpose downwardly extending slots 21b that separate the radiator halves 3a from each other are provided in the supporting mechanism 21 (the balancing means being part of this supporting mechanism). The slots end just before the base 21a located underneath which connects everything together.

As also emerges in particular from the exploded view in FIG. 2, the overall construction of the antenna arrangement is such that it comprises a printed circuit board 5, namely what is referred to as a PCB, which is preferably provided on the side 5a that faces the radiator side, what is known as the radiator or ground plane side 5a, with a preferably all-over electrically conductive ground plane 7. The electrical components and the strip conductors that connect the electrical components are then provided on the opposing strip conductor plane 5b (i.e. on the underside of the printed circuit board 5 that is not shown in detail in FIGS. 1 and 2).

The ground plane 7 is conventionally covered with an insulating layer 8, which is indicated in FIG. 2 only in the left-hand region, for example in the form of a plastics material or film layer, a paint layer, for example in the form of what is known as a solder resist later, etc.

Building thereon an arrangement 11 that is separately reproduced in FIG. 2 is disclosed which will hereinafter also be called the reflector frame 11. This reflector frame 11 comprises a coupling surface 13 which when finally assembled runs parallel to the ground plane 7. In the illustrated embodiment this coupling surface 13 is provided with longitudinal webs 15 and transverse webs 17 running perpendicular to the coupling surface 13 and in the illustrated embodiment these are formed and/or provided on the external limits of the reflector frame 11, although they may also be located offset and further in on the outer limits of the reflector frame 11, so a portion of the reflector that protrudes externally over the webs 15, 17 remains. These longitudinal and transverse webs 15, 17 are also connected to each other at the corner regions 19. The illustrated longitudinal or transverse webs do not have to be oriented perpendicular to the reflector surface 13. These webs can to some extent also run in an orientation to the reflector surface that differs by an angle of 90°, for example so as to diverge or converge in the beam direction or can be inclined more to the left or right, etc. In principle there are no limitations in this respect.

The reflector frame 11 is preferably an electrically conductive material, for example a metal cast part (aluminum, although other materials can also be considered here). This can also be a plastics part which is then metalized, i.e. has been coated with a metallically conductive surface. In particular when producing the reflector frame 11 from metal other production processes may be considered, for example production of the reflector frame by deep-drawing, milling or the like.

From the illustration according to FIGS. 1 and 2 it may also be seen that the coupling surface 13 is provided with a recess 13a which in the illustrated embodiment is so large in the longitudinal and transverse directions that the dual-polarized radiator 3 shown in FIGS. 1 and 2 also passes through this recess 13a with its radiator elements 3a.

To assemble the antenna arrangement the radiator assembly 3 is, for example, firstly mounted on the printed circuit board 5, i.e. in particular mechanically fixed, for example by fixing a screw that is to be screwed in from the back of the printed circuit board, or by other clip-like fastening elements, the supporting mechanism and/or balancing means 21, via which the radiator elements 3a of the dual-polarized radiator 3 are held, being capacitively coupled to the ground plane 7 of the printed circuit board 5 located underneath. The reflector frame 11 can also be connected to the printed circuit board for example by the above-described or other suitable mechanical measures.

As the printed circuit board 5, i.e. the ground plane 7 provided thereon, is covered by means of an insulating layer 8 (for example in the form of a paint layer), a capacitive coupling is produced between the underside of the supporting mechanism and/or balancing means 21 (i.e. between the electrically conductive base 21a of the radiator assembly 3 and the ground plane 7) and between the electrically conductive coupling surface 13 and the ground plane 7, i.e. a d.c. or galvanic connection of these parts is reliably avoided. In other words, the paint layer applied to the ground plane would be completely adequate as an insulator, so an additional insulating layer is not necessary to achieve the capacitive coupling.

However the reflector frame 11 is preferably fastened to the top of the printed circuit board 5 by means of double-sided adhesive film 9, the adhesive film 9 being provided with a window-like cut-out 9′, the size and positioning of which matches or approximates the cut-out 13a in the coupling surface 13 of the reflector frame 11. As the insulating layer 8 is conventionally always provided on the ground plane 7 in the form of a paint layer, this insulating layer primarily being used as corrosion protection for the ground plane which is often made of copper, said double-sided adhesive film would be glued to this insulating or paint layer 8. In such a case the ground plane 7 could also not be provided with an insulating layer 8 however.

The adhesive tape 9 can comprise said recess 9′ as it is irrelevant for the electrical functions whether the radiator device in the form of what is referred to as a vector dipole is also likewise held by means of said adhesive tape 9 with respect to the ground plane 7 or printed circuit board 5. The dipole is capacitively coupled (in this case via the lower base 21a) to the ground plane 7 employing the same principles as in relation to the reflector frame 11, so the spacing may also vary to a certain extent (for example 0.5 mm). This being the case, the adhesive film 9 could also be formed so as to be continuous and without window 9′, although this would have certain drawbacks in terms of internal conductor assembly for the radiator assembly 3 as in this case the internal conductor which is to be laid in the radiator device would have to be inserted through the adhesive tape 9. This being the case, the window-like recess 9′ is preferably provided in the adhesive tape 9. In the process the radiator is mounted on the printed circuit board by separate fixing measures while maintaining the capacitive coupling.

If the insulating layer 8 on the ground plane 7 should also be provided with a window, so the insulating layer 8 is omitted in the region of this window (it being possible for this region, where the insulating layer 8 is omitted on the ground plane, to comparably match the size and/or arrangement of the other window 9′ with respect to the double-sided adhesive device 9 and/or recess 13a in the coupling surface 13), the ground plane 7 would be “blank” in this region. In this case the base 21a, i.e. the underside of the supporting mechanism and/or balancing means 21, could also be galvanically connected to the ground plane 7. Holes and are formed in the printed circuit board and axial holes that align therewith are formed in the base 21a of the supporting mechanism and/or balancing means 21 of the radiator assemblies in order to upwardly guide a respective internal conductor, which is used for feeding, from the back of the printed circuit board and to galvanically couple, or inductively couple, as described for example in WO 2005/060049, it via a section of a bridge to the respective diagonally opposite second half 3a of the radiator device 3 located above. This being the case, reference is also made in this regard to the above anticipatory document with respect to the mode of operation.

Following the thus effected pre-assembly the reflector frame 11 is then positioned from above, the radiator assembly 3 then being guided through the recess 13a in the coupling surface 13 and through the recess 9′ in the double-sided adhesive device 9.

Any conceivable connecting methods may be considered to ensure a secure connection between the coupling surface 13, i.e. a secure connection between the reflector frame 11 and the printed circuit board. Thus for example glue can be applied to the top of the printed circuit board (i.e. the ground plane or the insulating layer 8 that covers the ground plane) and/or to the underside of the coupling surface 13. However clip-like parts that mesh when positioned and produce a latching are also possible.

The above-mentioned double-sided adhesive tape 9 is preferably used however, whereby a strictly predefined spacing between the coupling surface 13 and the ground plane 7 is ensured and a mechanically secure connection is produced at the same time. As a result of this type of connection the reflector frame 11 with the printed circuit board 5 constitutes a securely connected, self-supporting unit.

A capacitive coupling is ensured thereby which also ensures the desired capacitive connection of the ground plane for the longitudinal and/or transverse webs 15, 17.

If the longitudinal and transverse webs 15, 17 are not securely connected to each other in their corner regions 19, they can be bent toward or away from one another by different bending, in particular if the reflector frame is made from a metal sheet, whereby the radiation diagram of the antenna can be changed and/or adjusted to the desired extent.

FIG. 3 only reproduces an enlargement to the extent that the corresponding antenna arrangement can also comprise a plurality of radiator assemblies 3 that sit side by side or one above the other in the add-on direction, an antenna arrangement of this kind with a plurality of radiators conventionally being assembled in the vertical direction, so the plurality of radiator assemblies are arranged so as to be spaced apart one above the other in a vertical plane. The reflector frame can comprise a number of reflector fields 25 that matches the number of radiator arrangement. The size of the antenna arrangement can be enlarged as desired in this respect. In this case the double-sided adhesive tape 9 is preferably formed as a correspondingly elongated film which is provided with three recesses 9′ that match the three recesses or windows 13a in three thus formed reflector fields 25 of the reflector frame 11. The hole 26 worked into the printed circuit boards means, similar to in the embodiment according to FIG. 3, the respective radiator device can be fixed from below by screwing a screw into the base 21a of the supporting mechanism and/or balancing means 21 of the radiator device 13, an electrically non-conductive screw preferably being used, above all if the base of the supporting mechanism and/or balancing means of the radiator device 3 is to be capacitively coupled to the ground plane 7 of the printed circuit board 5.

With reference to FIGS. 4 to 6 a reflector frame for eight radiator assemblies or radiator groups is disclosed by way of example which, if the antenna arrangement and therefore the reflector frame are assembled in the vertical direction, comprise two continuous longitudinal webs 15 extending in the vertical direction and in the case of a total of eight reflector fields 25 comprises nine transverse webs 17. With reference to FIGS. 4 to 6 it is also disclosed that this reflector frame 11 can be produced for example from a metal sheet, i.e. from a sheet material, by punching and canting or bending.

It can be seen from the plane developed view according to FIG. 5 that it is not just one recess 13a that has been punched from the material, rather as a result of transverse and lateral punched sections 27 the material of the transverse webs 17 is ultimately also punched out.

Following the effected punching process according to FIG. 5 the longitudinal and transverse webs located in one plane can preferably be inclined upwards by 90°, the transverse webs 17 along the canting lines 17a in each case being assembled at preferably 90° with respect to the plane of the coupling surfaces 13. The two longitudinal webs 15 are assembled along the canting lines 15a at 90°.

As may also be seen from FIGS. 4 to 6 the punching process is performed such that a respective tongue 17c that protrudes from the transverse web 17 and into its plane is formed on the lateral edges 17b of the transverse webs 17. A respective slotted recess 15b is punched out of the two lateral webs 15 at an appropriate position in the finally produced reflector frame, so when the reflector frame is finally assembled the tongues 17c of the transverse webs 17 engage in the slotted recesses 15b of the longitudinal webs 15, as can be seen from FIGS. 4 and 6. The transverse webs 17 are also securely mechanically held and fixed in position thereby.

Otherwise the thus formed reflector frame 11 is positioned in the described manner, optionally with separate insertion of an insulating layer or film 9 on the ground plane 7, i.e. ultimately on the printed circuit board 5, and is suitably fixed thereto, as described preferably with insertion of a double-sided adhesive tape 9.

It is clear from the illustration that in this embodiment the window-like recess 13a is not just square but, in contrast, is also larger as once the transverse web 17 has been lifted up a corresponding rectangular portion is removed from the coupling surface. This being the case, the recess 13a is T-shaped in this instance. Only in the illustration according to FIG. 5 is the recess still square at the top right-hand edge, as in this embodiment the transverse web 27 located furthest right is tilted up via a bending edge 17a located, from its perspective, on the left, in other words no additional portion of material is removed from the coupling surface region here.

In contrast to FIGS. 4 and 5, FIG. 6 indicates only as a variation that the lateral portions of the coupling surface 13 can have different widths, depending on how wide the reflector arrangement formed by the ground plane should be in total. Finally it is noted that by way of example the transverse webs 17 do not have to be provided with lateral edges 17b running at a right angle to the bending edge 17a, instead the punch lines can also run obliquely here such that when assembled the two longitudinally running webs are not oriented perpendicularly to the reflector plane but can be oriented so as to, for example, diverge (or converge) in the beam direction. For the sake of completeness it is again emphasized that a respective recess 26 is provided in the printed circuit board in the centre of the radiator arrangement 3, via which recess, for example from the back of the printed circuit board 5, a screw (in the case of capacitive coupling, a plastic screw) can be screwed into the base 21a of the supporting mechanism and/or balancing means 21 in order to mechanically fix the radiator arrangement 3. Four size-reduced holes 31 are also apparent, via which an internal conductor for feeding the dual-polarized radiator arrangement can ultimately be supplied.

FIGS. 7 and 8 only indicate in a schematic section through a corresponding radiator arrangement how a dual-polarized or, in a similar manner, a mono-polarized radiator 3 can be fed.

Feeding conventionally takes place by means of a coaxial cable which runs from the underside of the reflector through an axial hole 103 leading in the supporting mechanism or balancing means 21 to the plane of the actual dipole and/or radiator halves 3a. The coaxial cable is stripped at the upper end of this axial hole at the level of the dipole and/or radiator halves 3a, so the external conductor, which is insulated in the axial hole 103 from the supporting mechanism and/or balancing means 21, is exposed and in the upper region is then electrically/galvanically connected for example by means of a soldering 201, to the inner end of an associated dipole or radiator half 3a. The drawings in FIG. 5 show substantially only the internal conductor 101b. The coaxial cable would therefore be laid from bottom to top through the axial hole 103, the external conductor, as mentioned, then being electrically-galvanically connected at the upper end of the supporting mechanism 21 to the associated dipole or radiator half 3a via the soldering 201. The external conductor is insulated from the supporting mechanism 21 up to this point.

Alternatively or preferably however a coaxial feeder cable is connected in such a way that the external conductor is held at the lower end of the hole 103, for example at a soldering point 201′, and the internal conductor 101b is held only by an insulator and is separately upwardly guided in the hole 103. The hole in the supporting mechanism therefore acts as an external conductor that surrounds the internal conductor 101b so a more or less coaxial feeder is formed hereby, via which the dipole and/or radiator halves, which as a rule are electrically-galvanically conductively connected to the supporting mechanism as a joint component, are fed.

If one dipole half (which is not fed via the internal conductor) is not fed by an electrical-galvanic coupling, for example in the region of the hole in the supporting mechanism, but for example by soldering-on of an external conductor of a coaxial cable, appropriate feeding can also be brought about capacitively, for example by a capacitive coupling between the base of the supporting mechanism and the ground plane or reflector surface. Therefore the associated feeder, usually the external conductor of a coaxial cable, is conventionally connected in a region underneath the supporting mechanism which, in plan view, is located perpendicularly to the reflector, preferably in the region underneath the dipole or radiator half that is fed thereby.

The internal conductor 101b which is conventionally connected to the internal conductor of a coaxial cable is usually bent substantially at the level of the dipole and/or radiator halves 3a by 90° or substantially 90° and leads to the adjacent inner end of the associated second dipole and/or radiator half 3a and is conventionally electrically connected there by means of soldering 203.

In the case of a dual-polarized radiator, feeding of the dipole and/or radiator halves 3a that are mutually offset by 90° takes place accordingly, the second internal conductor, running so as to cross the first internal conductor 101b, is arranged on a different plane so the two internal conductors do not touch in the middle but bypass each other.

In the case of a simply polarized radiator with just one polarization plane, only one feeder, which is also called an internal conductor, is required.

The embodiment according to FIG. 8 shows that the end 101b′ of the internal conductor 101b ends freely in a further axial hole 103, this further axial hole 103 being provided in the supporting and/or balancing mechanism 21. In this case the freely-ending end portion of the internal conductor 101b is guided downwards over a certain axial length in this further hole 103 and is held in the hole 103 by an insulator 203 (similar to the corresponding insulator 203 for fixing the internal conductor 101b in the other axial hole 103), whereby a capacitive or serial coupling is effected here with respect to the second dipole and/or radiator half 3a′.

Other types of feeding are also possible.

It is mentioned purely for the sake of completeness that it may also be seen from FIGS. 7 and 8 for example that in this case the slots 123 extend up to the lower plane or base 121 of the supporting and/or balancing mechanism 21. The height of this supporting and/or balancing mechanism 21 or the slots 123 should preferably be in a range from about ⅛ to ⅜ of a wavelength from the relevant operating frequency band that is to be transmitted or received. The height should therefore preferably be ⅛ to ⅜, based on the mean wavelength λ of the frequency band that is to be transmitted or received, i.e. preferably at about ¼λ. In general the radiator height with respect to the reflector, i.e. with respect to the ground plane or reflector surface, should therefore not fall below a value of λ/10, wherein, in principle, there is no upper limit, so the radiator height could even be any multiple of λ. The length of the slots 123 can then be adjusted accordingly.

1. An antenna arrangement, comprising:
at least one radiator assembly, which comprises a dipole array having a supporting mechanism,
a reflector arrangement, comprising an electrically conductive reflector surface, and at least one electrically conductive longitudinal web or at least one electrically conductive transverse web,
the reflector arrangement comprising a printed circuit board comprising a side on which an electrically conductive ground plane is provided,
the reflector arrangement also comprising a reflector frame,
the reflector frame comprising a coupling surface that runs parallel to the printed circuit board and/or the ground plane,
the coupling surface being capacitively coupled to the ground plane,
the coupling surface being mechanically and electrically-galvanically connected to the at least one longitudinal web or to the at least one transverse web;
the coupling surface comprising a recess via which the ground plane, which is located underneath it, the printed circuit board or an insulating layer, which is provided above the ground plane or above the printed circuit board, is exposed, and
the at least one radiator assembly is positioned and/or held on the printed circuit board in the region of the recess.

2. The antenna arrangement as claimed in claim 1, wherein the reflector frame comprises at least two longitudinal webs and/or at least two transverse webs.

3. The antenna arrangement as claimed in claim 1, wherein the at least one longitudinal web and/or the at least one transverse web is constructed with the coupling surface as a one-piece metal part.

4. The antenna arrangement as claimed in claim 3, wherein the at least one longitudinal web and/or the at least one transverse web is bent on a bending line with respect to the coupling surface in different angular direction with respect to the coupling surface.

5. The antenna arrangement as claimed in claim 1, wherein the reflector frame consists of a cast part, deep-drawn part, punched part and/or a milled part.

6. The antenna arrangement as claimed in claim 1, wherein the reflector or reflector frame is made from an insulating material or plastics material and is covered with an electrically conductive layer.

7. The antenna arrangement as claimed in claim 1, wherein the reflector frame is connected to the printed circuit board by mechanical connecting means.

8. The antenna arrangement as claimed in claim 7, wherein the reflector frame is securely connected to the printed circuit board by means of a clip and/or latching and/or snap-fit mechanism.

9. The antenna arrangement as claimed in claim 1, wherein the reflector frame is glued to the printed circuit board.

10. The antenna arrangement as claimed in claim 1, wherein the reflector frame is securely connected to the printed circuit board by using a double-sided adhesive tape and/or a double-sided adhesive film or the like.

11. The antenna arrangement as claimed in claim 10, wherein the adhesive tape or adhesive film has a recess, of which the size and/or position matches at least the size and/or position of a corresponding recess, or is smaller.

12. The antenna arrangement as claimed in claim 10, wherein the adhesive tape or adhesive film is provided between the underside of the coupling surface and the ground plane or an insulating layer that covers the ground plane and furthermore in the region of the recess in the coupling surface.

13. The antenna arrangement as claimed in claim 12, wherein the adhesive tape or the adhesive film is provided on the printed circuit board between the underside of the coupling surface and the ground plane or an insulating layer that covers the ground plane and furthermore in the region of the recess and in the region between the base of the supporting mechanism and/or balancing means of the radiator assembly and the ground plane.

14. The antenna arrangement as claimed in claim 1, wherein the radiator assembly is capacitively coupled to the ground plane on the printed circuit board.

15. The antenna arrangement as claimed in claim 14, wherein the radiator assembly is capacitively coupled by its associated base of a supporting mechanism and/or balancing means to the ground plane on the printed circuit board.

16. The antenna arrangement as claimed in claim 1, wherein the radiator assembly is d.c.-, i.e. galvanically, connected to the ground plane on the printed circuit board.

17. The antenna arrangement as claimed in claim 16, wherein the radiator assembly is d.c.-, i.e. galvanically, connected by its base of a supporting and/or balancing mechanism to the ground plane on the printed circuit board.

18. The antenna arrangement as claimed in claim 1, wherein the reflector frame is produced from a metal sheet by punching and canting or bending.

19. The antenna arrangement as claimed in claim 18, wherein the transverse webs are punched from a common sheet metal part and are securely connected to the coupling surface via a respectively associated bending line.

20. The antenna arrangement as claimed in claim 18, wherein the longitudinal webs are connected to the coupling surface via a bending line.

21. The antenna arrangement as claimed in claim 18, wherein at their lateral limiting edges the transverse webs are provided with lugs and/or tongues that laterally protrude in the plane of the lateral webs and which in the assembled state project into recesses in the longitudinal webs with orientation of the transverse webs pointing away from the reflector surface.

22. The antenna arrangement as claimed in claim 21, wherein in the assembled state the lugs and/or tongues project into slotted recesses in the longitudinal webs.

23. The antenna arrangement as claimed in claim 1, wherein one radiator device per recess is arranged in a coupling surface.

24. The antenna arrangement as claimed in claim 1, wherein the supporting mechanism of the dipole array comprises a balancing means.

25. The antenna arrangement as claimed in claim 1, wherein the at least one radiator device consists of a dual-polarized dipole array by using a supporting mechanism.
